(19) United States
(12) Patent Application Publication
(10) Pub. No.: US 2026/0183905 A1
(43) Pub. Date: Jul. 2, 2026

(54) HAND TOOL WITH PRECISE ROTATION FUNCTION

(71) Applicant: YIH CHENG FACTORY CO., LTD., Nantuo (TW)

(72) Inventor: Jack LIN, Nantuo (TW)

(21) Appl. No.: 19/004,260

(22) Filed: Dec. 28, 2024

(51) Int. Cl. B25B 13/46

(52) U.S. Cl. CPC B25B 13/466

(57) ABSTRACT

A hand tool (1) with a precise rotation function is provided. The hand tool (1) includes a grip (10) with a working end (11), a ratchet ring (20) with ratchet teeth (21) for precise engagement, and a ring post (30) with a through hole. The ring post (30) also includes a notch (31), two accommodating slots (32), and a switching slot (33). A knob (40) with a switching lever (42) interacts with the switching slot (33), enabling precise adjustments. A latching assembly (50) including a positioning spring sheet (51) and the elastic latching units (52), ensures engagement. The tool shaft (60) is inserted through the knob cap (41), the through hole, and the ratchet ring (20), and is fixed in the grip (10). This arrangement provides precise rotation by rotating the knob (40), increasing the convenience of use.

### BACKGROUND OF THE DISCLOSURE

### Technical Field

The present application relates to a hand tool, and particularly, to a hand tool with a precise rotation function.

### Description of Related Art

Related-art screwdrivers achieve a unidirectional rotation via a ratchet mechanism, enabling users to tighten or loosen screws or bolts in one direction without repositioning the handle. When the handle is reversed, the ratchet mechanism disengages, maintaining the tool head's position and significantly enhancing operational efficiency.

However, as the ratchet design favors quick and efficient operation over precise adjustments, its inability to make fine adjustments in delicate applications presents a significant drawback, leading to inconvenience.

In response, the Applicant has extensively researched the existing technology and applied theoretical knowledge to diligently address these issues, forming the basis of this improvement.

### SUMMARY OF THE INVENTION

An objective of the present disclosure is to provide a hand tool with a precise rotation function, achieved by turning a knob to facilitate precise adjustments, thereby enhancing convenience and usability.

To achieve the above objective, the present disclosure provides a hand tool with a precise rotation function. The grip includes a working end. The ratchet ring includes a ring portion and a neck portion connected to the ring portion. An inner wall surface of the ring portion includes a plurality of ratchet teeth. The neck portion is inserted in the working end. The ring post is disposed in the ring portion. A through hole extends through a center of the ring post. An outer peripheral surface of the ring post includes a notch, a pair of accommodating slots, and a switching slot. The ring post forms a first stop wall on one side of the switching slot and a second stop wall on another side. The knob includes a knob cap and a switching lever disposed within the knob cap. The knob cap includes a plurality of grooves and fitted on the outside of the ratchet ring. The switching lever protrudes into the switching slot and abuts against the first stop wall or the second stop wall upon rotation of the knob cap. The latching assembly includes a positioning spring sheet and a pair of elastic latching units. The positioning spring sheet is disposed in the notch and positioned in one of the grooves. Each elastic latching unit is disposed in one of the accommodating slots and is engaged or pressed by one of the ratchet teeth. The tool shaft is inserted through the knob cap, the through hole, and the ratchet ring, and is fixed in the grip.

Compared with the related art, the hand tool with the precise rotation function of the present disclosure may switch the rotation direction by rotating the knob. When the grip rotates clockwise, the ratchet teeth of the ratchet ring continuously press against the pressing surface of the latching piece, and at this time, the grip rotates idly relative to the ring post. On the other hand, when the grip rotates counterclockwise, the ratchet teeth of the ratchet ring are blocked by the blocking surface of the latching piece. Therefore, when the grip rotates counterclockwise, the grip drives the ring post to rotate counterclockwise. Accordingly, the tool shaft may rotate when the grip rotates counterclockwise. Furthermore, when the knob of the present disclosure is rotated counterclockwise until the switching lever abuts against the first stop wall, the tool shaft is not only rotated by the grip rotating counterclockwise, but also rotate precisely with the knob counterclockwise. Similarly, the opposite rotation direction offers the same rotation function, enhancing the convenience of use of the hand tool of the present disclosure.

### BRIEF DESCRIPTION OF THE DRAWINGS

FIGS. 1 and 2 are perspective views from two lateral sides of a hand tool with a precise rotation function.

FIG. 3 is an exploded perspective view of the hand tool with the precise rotation function of the present disclosure.

FIG. 4 is a perspective view of a knob of the present disclosure.

FIG. 5 is an assembled cross-sectional view of the hand tool of the present disclosure.

FIGS. 6 and 7 are schematic views illustrating the use of the hand tool of the present disclosure.

FIGS. 8 and 9 are another schematic views illustrating the use of the hand tool of the present disclosure.

FIGS. 10 and 11 are yet another schematic views illustrating the use of the hand tool of the present disclosure.

### DETAILED DESCRIPTION

The detailed description and technical contents of the present disclosure are described below with reference to the drawings. However, the accompanying drawings are provided for reference and illustration purposes only, and are not intended to limit the present disclosure.

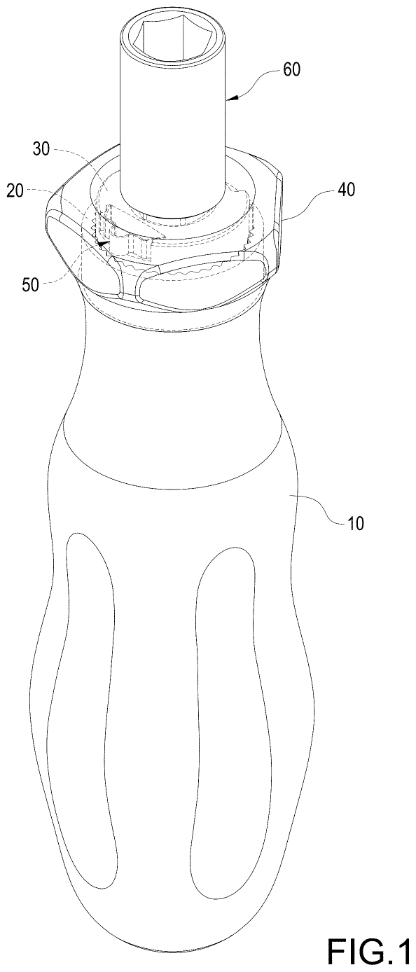

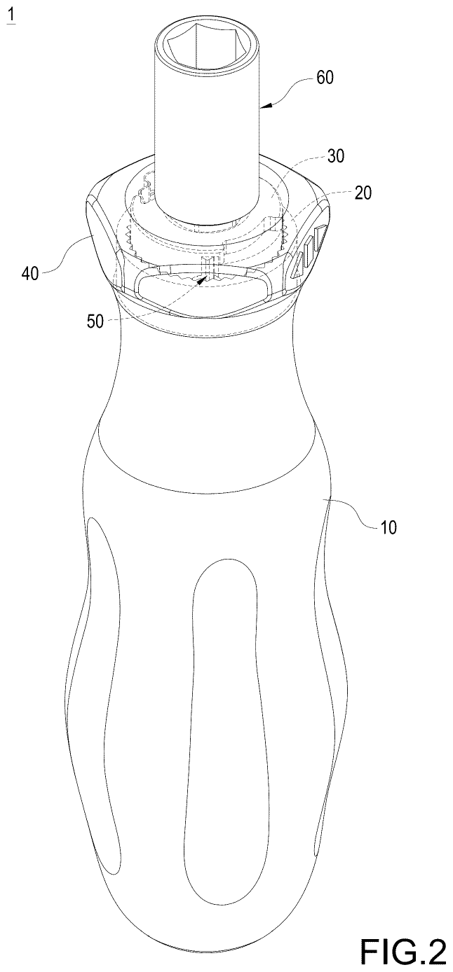

Referring to FIGS. 1 and 2, there are shown perspective views from two lateral sides of a hand tool with a precise rotation function of the present disclosure. The hand tool 1 with the precise rotation function of the present disclosure includes a grip 10, a ratchet ring 20, a ring post 30, a knob 40, a latching assembly 50, and a tool shaft 60. The ratchet ring 20 is coupled to the grip 10. The latching assembly 50 is installed in the ring post 30, and is disposed in the ratchet ring 20 together with the ring post 30. The knob 40 is fitted on the outside of (or sheathes) the ratchet ring 20. One end of the tool shaft 60 passes through the ring post 30 and the ratchet ring 20, and is fixed in the grip 10. The other end of the tool shaft 60 protrudes from the knob 40 for rotating a screw or a nut. A more detailed description of the hand tool 1 with the precise rotation function is provided below.

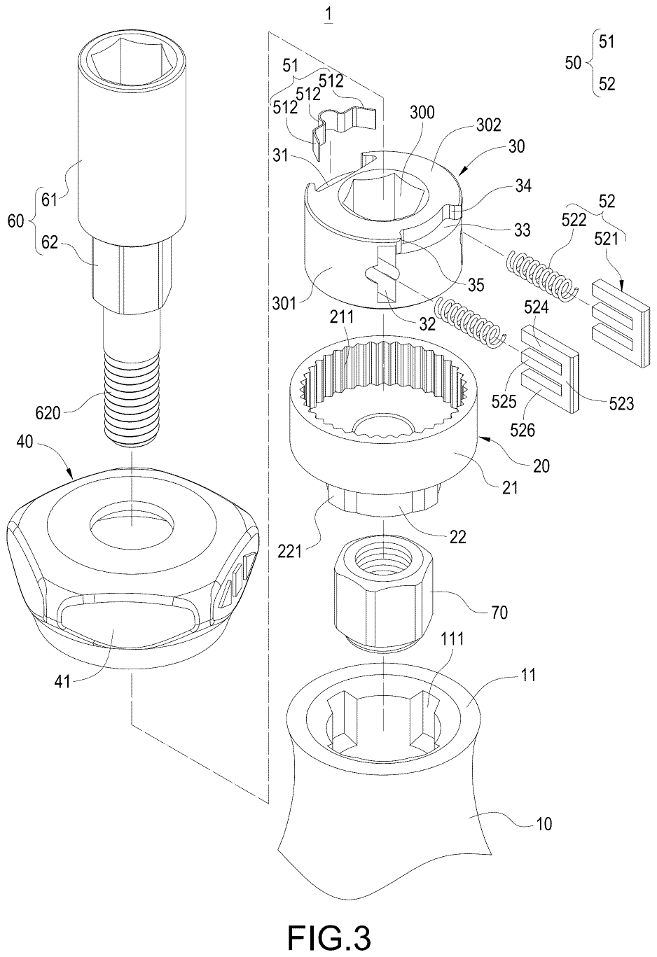

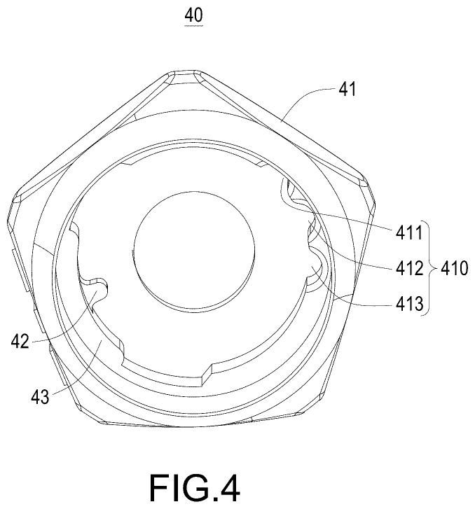

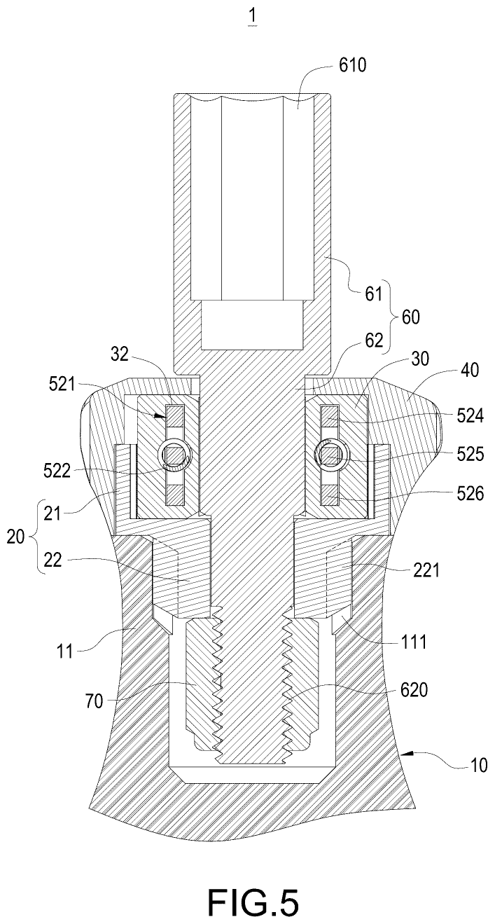

Referring to FIGS. 3 to 5, there are shown an exploded perspective view of the hand tool with the precise rotation function of the present disclosure, a perspective view of the knob, and a cross-sectional view of the assembled hand tool. The grip 10 of the present disclosure includes a working end 11. The ratchet ring 20 includes a ring portion 21 and a neck portion 22 connected to the ring portion 21. An inner wall surface of the ring portion 21 includes a plurality of ratchet teeth 211. The neck portion 22 is inserted in the working end 11. In this embodiment, the working end 11 includes a plurality of slots 111. In addition, an outer peripheral surface of the neck portion 22 includes a plurality of protrusions 221. The protrusions 221 are engaged with the slots 111 to secure the neck portion 22 to the working end 11.

Further, the ring post 30 is disposed in the ring portion 21. A through hole 300 extends through a center of the ring post 30, and an outer peripheral surface 301 of the ring post 30 includes a notch 31, a pair of accommodating slots 32, and a switching slot 33. The ring post 30 is formed with a first stop wall 34 on one side of the switching slot 33 and a second stop wall 35 on another side of the switching slot 33. In this embodiment, the pair of accommodating slots 32 are located on the outer peripheral surface 301 of the ring post 30, and are arranged opposite to each other on one side of the first stop wall 34 and the second stop wall 35. In addition, the notch 31 and the switching slot 33 are located on opposite sides of the ring post 30, and are located on a top surface 302 of the ring post 30.

The knob 40 includes a knob cap 41 and a switching lever 42 disposed within the knob cap 41. The knob cap 41 includes a plurality of grooves 410 and fitted on the outside of the ratchet ring 20. The switching lever 42 protrudes into the switching slot 33 and abuts against the first stop wall 34 or the second stop wall 35 upon rotation of the knob cap 41. In this embodiment, the grooves 410 include a first groove 411, an intermediate groove 412, and a second groove 413. Further, an inner wall surface of the knob cap 41 is formed with a latching block 43. The switching lever 42 protrudes from a middle position of the latching block 43 towards a center of the knob cap 41, and the size of the latching block 43 is designed corresponding to the size of the switching slot 33.

Furthermore, the latching assembly 50 includes a positioning spring sheet 51 and a pair of elastic latching units 52. The positioning spring sheet 51 is disposed in the notch 31 and positioned in one of the grooves 410. Each elastic latching unit 52 is disposed in one of the accommodating slots 32 and is engaged or pressed by one of the ratchet teeth 211.

In this embodiment, the positioning spring sheet 51 includes a convex arc 511 and two spring arms 512 connected to the convex arc 511. The size of the convex arc 511 is tailored corresponding to the size of the groove 410. The two spring arms 512 respectively abut against two opposite wall surfaces of the notch 31. In addition, each latching unit 52 includes a latching piece 521 and a spring 522 elastically abutting against the latching piece 521. One end of the latching piece 521 protrudes from the accommodating slot 32 and retracts into the accommodating slot 32 when pressed by one of the ratchet teeth 211.

Specifically, a cross-section of each latching piece 521 is E-shaped, including a straight rib 523 and a first transverse rib 524, a second transverse rib 525, and a third transverse rib 526 extending laterally from the straight rib 523. One side of the straight rib 523 is engaged or pressed by one of the ratchet teeth 211. In addition, the spring 522 sheathes the second transverse rib 525.

Further, the tool shaft 60 extends through the knob cap 41, the through hole 300 of the ring post 30, and the ratchet ring 20, and is secured in the grip 10. The hand tool 1 of the present disclosure further includes a locking member 70 positioned at the working end 11. One end of the tool shaft 60 is coupled to the grip 10 through the locking member 70. Specifically, the tool shaft 60 includes a working section 61 and a fixing section 62 connected to the working section 61. The working section 61 protrudes from the working end 11 of the grip 10 and includes a tool hole 610. Further, the fixing section 62 includes a plurality of threads 620. Accordingly, the end of the tool shaft 60 is securely attached to the working end 11 through threaded connection between the threads 620 and the locking member 70.

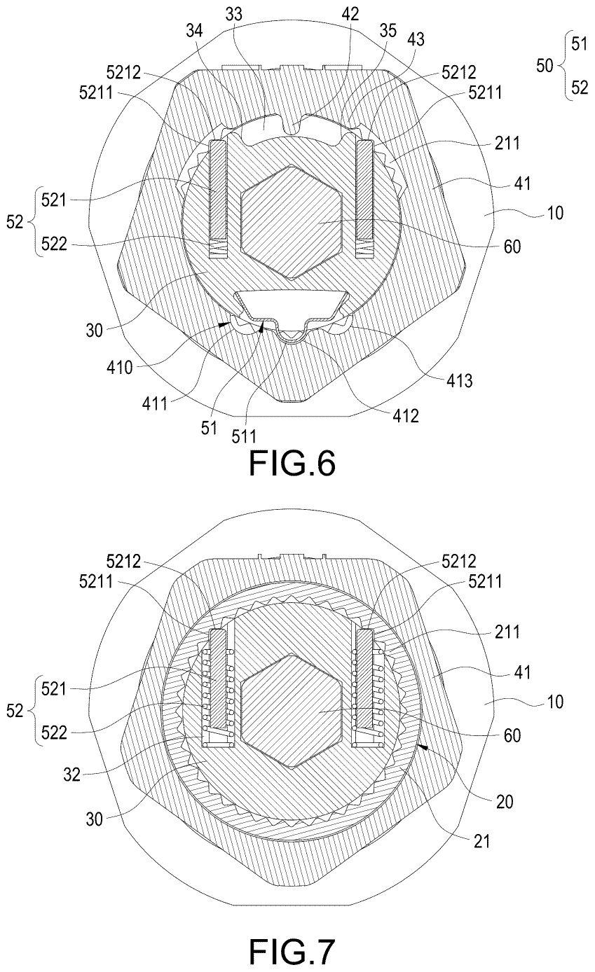

Please refer further to FIGS. 6 and 7, illustrating the use of the hand tool of the present disclosure. As shown in FIG. 6, when the knob 40 of the present disclosure is not rotated, the convex arc 511 of the positioning spring sheet 51 is positioned in the intermediate groove 412. Specifically, the latching piece 521 of the present disclosure includes a blocking surface 5211 and a pressing surface 5212. The blocking surface 5211 and the pressing surface 5212 are perpendicular to each other and are blocked or pressed by the ratchet teeth 211 of the ratchet ring 20. It is worth noting that the switching lever 42 is located at a middle position of the switching slot 33. In addition, the latching block 43 of the knob 40 is disposed between the first stop wall 34 and the second stop wall 35, and the latching block 43 does not press against any elastic latching unit 52. At this time, the latching piece 521 of the elastic latching unit 52 (first latching unit) near the first stop wall 34 and the latching piece 521 of the other elastic latching unit 52 (second latching unit) near the second stop wall 35 protrude from their respective accommodating slots 32.

As shown in FIG. 7, the grip 10 of the present disclosure may be rotated in both directions under the action of the elastic latching unit 52 (first latching unit) near the first stop wall 34 and the other elastic latching unit 52 (second latching unit) near the second stop wall 35. Specifically, when the grip 10 rotates clockwise or counterclockwise, the ratchet teeth 211 of the ratchet ring 20 are blocked by the blocking surface 5211 of the latching piece 521. Therefore, when the grip 10 rotates clockwise or counterclockwise, the grip 10 drives the ring post 30 to rotate clockwise or counterclockwise. Accordingly, the tool shaft 60 may rotate clockwise or counterclockwise with the grip 10.

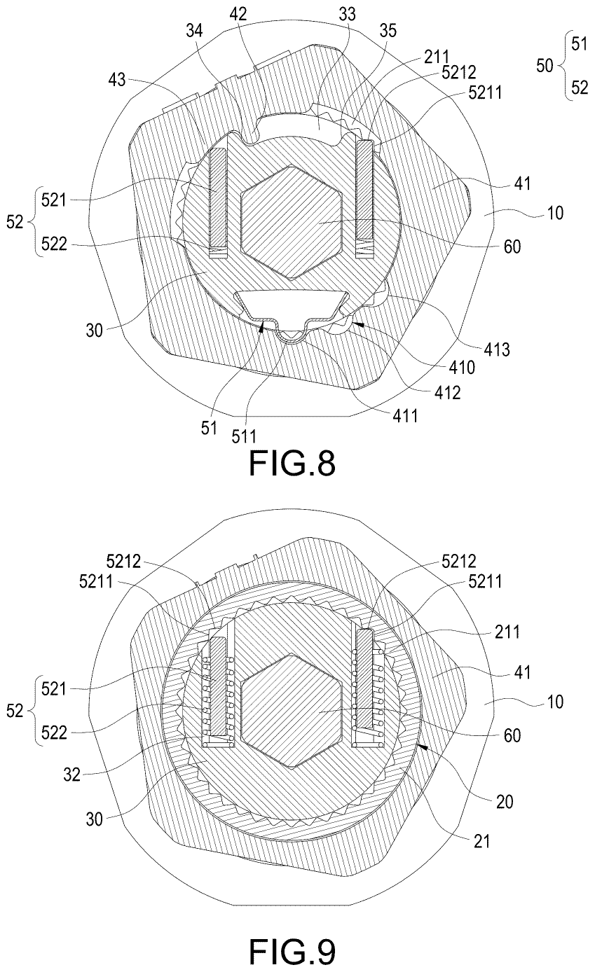

Referring further to FIGS. 8 and 9, another illustrative use of the hand tool of the present disclosure is shown. The rotational direction of the hand tool 1 of the present disclosure may be switched by rotating the knob 40. As shown in FIG. 8, when the knob 40 of the present disclosure is rotated counterclockwise, the switching lever 42 moves along the switching slot 33 and abuts against the first stop wall 34, and the convex arc 511 of the positioning spring sheet 51 is positioned in the first groove 411. At this time, the elastic latching unit 52 (first latching unit) near the first stop wall 34 is pressed by the latching block 43 and retracted into the accommodating slot 32. In addition, for the other elastic latching unit 52 (second latching unit) near the second stop wall 35, one outer end of the latching piece 521 protrudes from the accommodating slot 32. More specifically, the latching piece 521 of the present disclosure includes a blocking surface 5211 and a pressing surface 5212. The blocking surface 5211 and the pressing surface 5212 are perpendicular to each other and are blocked or pressed by the ratchet teeth 211 of the ratchet ring 20.

As shown in FIG. 9, after the knob 40 of the present disclosure is rotated counterclockwise, the ratchet ring 20 rotates with the rotation of the grip 10. The elastic latching unit 52 (first latching unit), positioned near the first stop wall 34 in the latching assembly 50, retracts into the accommodating slot 32. The grip 10 may be rotated unidirectionally under the action of the elastic latching unit 52 (second latching unit) near the second stop wall 35. Specifically, when the grip 10 rotates clockwise, the ratchet teeth 211 of the ratchet ring 20 continuously press against the pressing surface 5212 of the latching piece 521. At this time, the grip 10 idles relative to the ring post 30. On the other hand, when the grip 10 rotates counterclockwise, the ratchet teeth 211 of the ratchet ring 20 are blocked by the blocking surface 5211 of the latching piece 521. Therefore, when the grip 10 rotates counterclockwise, the grip 10 drives the ring post 30 to rotate counterclockwise. Accordingly, the tool shaft 60 may rotate when the grip 10 rotates counterclockwise.

It should be noted that when the knob 40 is rotated counterclockwise until the switching lever 42 engages the first stop wall 34, not only the tool shaft 60 is rotated by the grip 10 in the counterclockwise direction, but it may also undergo precise rotation together with the knob 40 in the counterclockwise direction.

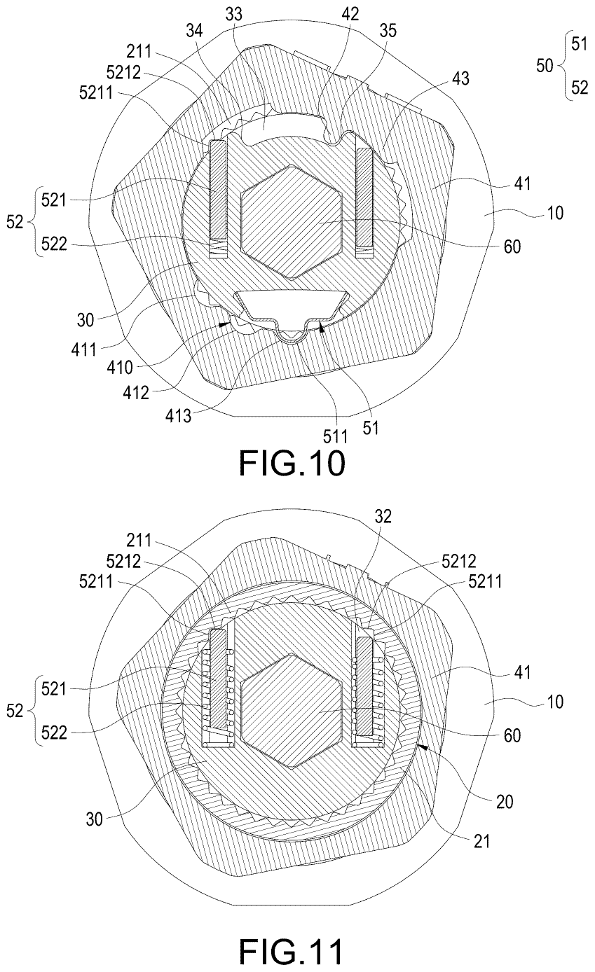

Referring further to FIGS. 10 and 11, yet another illustrative use of the hand tool of the present disclosure is shown. As shown in FIG. 10, when the knob 40 of the present disclosure is rotated clockwise, the switching lever 42 moves along the switching slot 33 and abuts against the second stop wall 35, and the convex arc 511 of the positioning spring sheet 51 is positioned in the second groove 413. At this time, the elastic latching unit 52 (second latching unit) near the second stop wall 35 is pressed and retracted into the accommodating slot 32 by the latching block 43. In addition, for the elastic latching unit 52 (first latching unit) near the first stop wall 34, one outer end of the latching piece 521 protrudes from the accommodating slot 32.

As shown in FIG. 11, after the knob 40 of the present disclosure is rotated clockwise, the ratchet ring 20 rotates with the rotation of the grip 10. The elastic latching unit 52 (second latching unit) in the latching assembly 50 near the second stop wall 35 retracts into the accommodating slot 32. The grip 10 may be rotated unidirectionally under the action of the elastic latching unit 52 (first latching unit) near the first stop wall 34. Specifically, when the grip 10 rotates counterclockwise, the ratchet teeth 211 of the ratchet ring 20 continuously press against the pressing surface 5212 of the latching piece 521. At this time, the grip 10 idles relative to the ring post 30. On the other hand, when the grip 10 rotates clockwise, the ratchet teeth 211 of the ratchet ring 20 are blocked by the blocking surface 5211 of the latching piece 521. Therefore, when the grip 10 rotates clockwise, the grip 10 drives the ring post 30 to also rotate clockwise. Accordingly, the tool shaft 60 may rotate when the grip 10 rotates clockwise.

It should be noted that when the knob 40 is turned clockwise until the switching lever 42 engages the second stop wall 35, not only the tool shaft 60 is rotated with the grip 10 in the clockwise direction, but it also performs precise rotations in sync with the clockwise movement of the knob 40.

The foregoing describes only preferred embodiments of this disclosure and is not intended to limit the scope of the disclosure. Any equivalent modifications that utilize the spirit of the disclosure should also fall within the scope of the disclosure.

What is claimed is:

1. A hand tool (1), comprising:
a grip (10), comprising a working end (11);
a ratchet ring (20), comprising a ring portion (21) and a neck portion (22) connected to the ring portion (21), the ring portion (21) comprising a plurality of ratchet teeth (211) disposed on an inner wall surface thereof, and the neck portion (22) inserted in the working end (11);
a ring post (30), disposed in the ring portion (21), a through hole defined on a center of the ring post (30), the ring post (30) comprising a notch (31), a pair of accommodating slots (32), and a switching slot (33) all defined on an outer peripheral surface thereof, wherein the ring post (30) further comprises a first stop wall (34) disposed on one side of the switching slot (33) and a second stop wall (35) disposed on another side of the switching slot (33);
a knob (40), comprising a knob cap (41) and a switching lever (42) disposed in the knob cap (41), the knob cap (41) comprising a plurality of grooves (410) and mounted externally on the ratchet ring (20), the switching lever (42) protruding into the switching slot (33) and abutting against the first stop wall (34) or the second stop wall (35) upon rotation of the knob cap (41);
a latching assembly (50), comprising a positioning spring sheet (51) and a pair of elastic latching units (52), the positioning spring sheet (51) disposed in the notch (31) and positioned in one of the grooves (410), each elastic latching unit (52) disposed in each accommodating slot (32) and engaged or pressed by one of the ratchet teeth (211); and
a tool shaft (60), inserted in the knob cap (41), the through hole, and the ratchet ring (20), and fixed in the grip (10).

2. The hand tool (1) as claimed in claim 1, further comprising a locking member (70) disposed at the working end (11), one end of the tool shaft (60) coupled to the grip (10) through the locking member (70).

3. The hand tool (1) as claimed in claim 1, wherein the neck portion (22) comprises a plurality of protrusions (221) disposed on an outer peripheral surface thereof, the working end (11) comprises a plurality of slots (111), and the neck portion (22) is positioned on the working end (11) through the protrusions (221) being engaged with the slots (111).

4. The hand tool (1) as claimed in claim 1, wherein the notch (31) and the switching slot (33) are located on two sides of the ring post (30) opposite to each other and arranged on a top surface of the ring post (30).

5. The hand tool (1) as claimed in claim 1, wherein the pair of accommodating slots (32) is located on the outer peripheral surface of the ring post (30) and disposed opposite to each other on one side of the first stop wall (34) and the second stop wall (35).

6. The hand tool (1) as claimed in claim 1, wherein the knob cap (41) comprises a latching block (43) disposed on an inner wall surface thereof, the switching lever (42) protrudes from a middle position of the latching block (43) towards a center of the knob cap (41), and a size of the latching block (43) is set correspondingly with a size of the switching slot (33).

7. The hand tool (1) as claimed in claim 1, wherein the positioning spring sheet (51) comprises a convex arc (511) and two spring arms (512) connected to the convex arc (511), a size of the convex arc (511) is set correspondingly with a size of the groove (410), and the two spring arms (512) respectively abut against two wall surfaces of the notch (31) opposite to each other.

8. The hand tool (1) as claimed in claim 1, wherein each elastic latching unit (52) comprises a latching piece (521) and a spring (522) elastically abutting against the latching piece (521), and one end of the latching piece (521) protrudes from the accommodating slot (32) and retracts into the accommodating slot (32) when pressed by one of the ratchet teeth (211).

9. The hand tool (1) as claimed in claim 8, wherein a cross-section of each latching piece (521) is E-shaped, each latching piece (521) comprises a straight rib (523) and a first transverse rib (524), a second transverse rib (525), and a third transverse rib (526) extending laterally from the straight rib (523), one side of the straight rib (523) is engaged or pressed by one of the ratchet teeth (211), and the spring (522) is adapted to sheathe the second transverse rib (524).

10. The hand tool (1) as claimed in claim 1, wherein the tool shaft (60) comprises a working section (61) and a fixing section (62) connected to the working section (61), the working section (61) protrudes from the working end (11) of the grip (10) and comprises a tool hole (610), and the fixing section (62) comprises a plurality of threads (620).
